(19) United States
(12) Patent Application Publication
(10) Pub. No.: US 2009/0225471 A1
(43) Pub. Date: Sep. 10, 2009

(54) DISK DEVICE

(75) Inventor: Hideaki KAMEZAWA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/397,827

(22) Filed: Mar. 4, 2009

(30) Foreign Application Priority Data
Mar. 4, 2008 (JP) 2008-054090

(51) Int. Cl. G11B 5/012

(52) U.S. Cl. 360/98.01; G9B/5.024

(57) ABSTRACT

A disk device includes: an enclosure to enclose a cavity; a plurality of disk media rotatably mounted in the enclosure and arranged along a rotation axis; and heads, movably mounted in the enclosure, to read/record data from/onto corresponding disk media; at least a first one of the disk media exhibiting a structural rigidity different than at least a second of the disk media.

### CROSS-REFERENCE TO RELATED APPLICATION

This application is based upon and claims the benefit of priority from the prior Japanese Patent Application No. 2008-54090 filed on Mar. 4, 2008, the entire contents of which are incorporated herein by reference.

### FIELD

The embodiment discussed herein is related to a device and, in particular, to a disk device including multiple disk media.

### BACKGROUND

In a hard disk drive (hereinafter referred to as the “HDD”), conventionally one or more magnetic disks (disk media) are rotated and driven by a spindle motor to write data on their recording surfaces and read data from the recording surfaces. If multiple magnetic disks are provided, they are disposed on the same rotation axis at a predetermined spacing and are integrally rotated and driven. Data is read and written (recorded and reproduced) by multiple read-write heads each of which is associated with each of the recording surfaces (both surfaces) of each magnetic disk. Each read-write head is positioned above a desired track of the magnetic disk by pivoting of a head gimbal assembly (HGA) holding a head slider about a predetermined spindle.

The rotation speeds of magnetic disks have been increased in recent years in order to improve the data read and write rates of HDDs. However, as the rotation speeds and the storage densities of magnetic disks have increased, degradation of accuracy of writing and reading due to flutter (a phenomenon in which a magnetic head swings in the direction of the radius of the magnetic disk due to an air flow generated by rotation of the magnetic disk) has become significant. This is because the relative positional relationship between the magnetic disk and the read-write head is changed by the occurrence of flutter and data is read from or written into a track different from the track from which the data is to be read or into which the data is to be written. The occurrence of flutter is also considered as a cause of exacerbation of NRRO (Non Repeatable Runout) of magnetic disks.

More recently, a technique has been proposed in which the spacing between magnetic disks in the center in the axial direction among the multiple magnetic disks are chosen to be greater than the spacing between the other magnetic disks in order to suppress the occurrence of flutter (See for example Japanese Laid-Open Patent Publication No. 2002-93118.)

However, the technique in which magnetic disks in the center in the axial direction are spaced farther apart than the other magnetic disks as described in the Japanese Patent Laid-Open No. 2002-93118 is practically applicable only to HDDs in which there are at least three spacings, that is, HDDs that include four or more magnetic disks. Therefore, there is a demand for a technique for reducing flutter (and NRRO) that is also applicable to HDDs including less than four magnetic disks.

Therefore, the present invention has been made in light of the problem and an object of the present invention is to provide a disk device capable of effectively suppressing write and read errors on multiple (two or more) magnetic disks caused by flutter.

### SUMMARY

According to an embodiment of the present invention, a disk device includes: an enclosure to enclose a cavity; a plurality of disk media rotatably mounted in the enclosure and arranged along a predetermined rotation axis; and heads, movably mounted in the enclosure, to read/record recording and reproducing data from/onto on each the corresponding disk media, respectively; at least a first one of the plurality of disk media exhibiting a structural rigidity different than at least a second of the plurality of disk media.

It is to be understood that both the foregoing general description and the following detailed description are exemplary and explanatory and are not restrictive of the invention, as claimed.

### BRIEF DESCRIPTION OF THE DRAWINGS

FIG. 1 is a longitudinal sectional view of an HDD according to one example of an embodiment of the present invention;

FIG. 2 is a longitudinal sectional view of a conventional HDD;

FIG. 3 is a graph illustrating measured NRRO of the magnetic disks at the top and bottom in the HDD in FIG. 2;

FIG. 4 is a graph illustrating measured NRRO of magnetic disks having different thicknesses; and

FIG. 5 is a longitudinal sectional view of an HDD according to another example of an embodiment of the present invention.

FIG. 6 is a longitudinal sectional view of an HDD according to another example of an embodiment of the present invention.

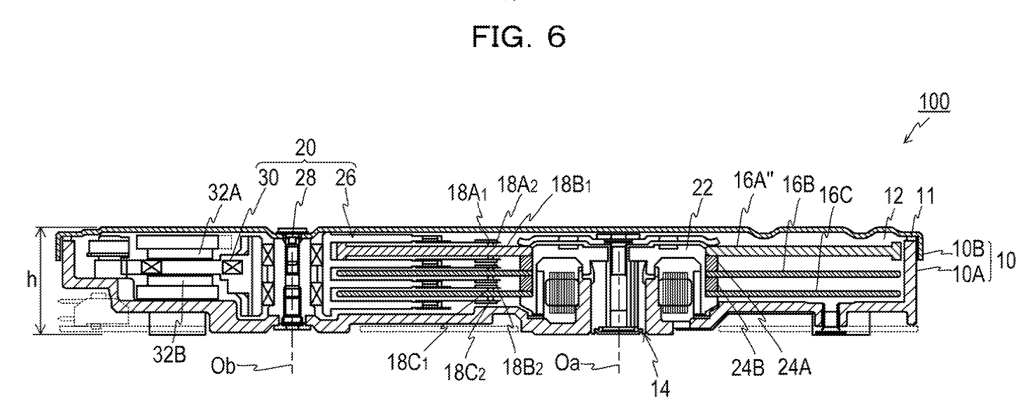

FIG. 7 is a longitudinal sectional view of an HDD according to another example of an embodiment of the present invention.

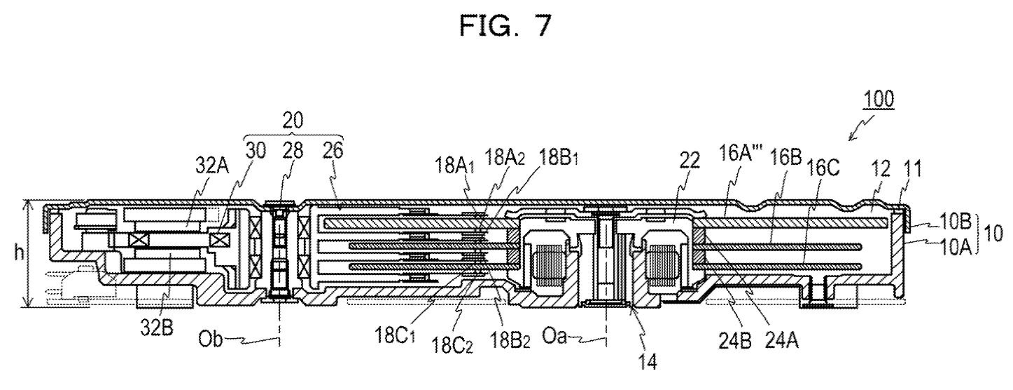

### DETAILED DESCRIPTION OF EXAMPLE EMBODIMENTS

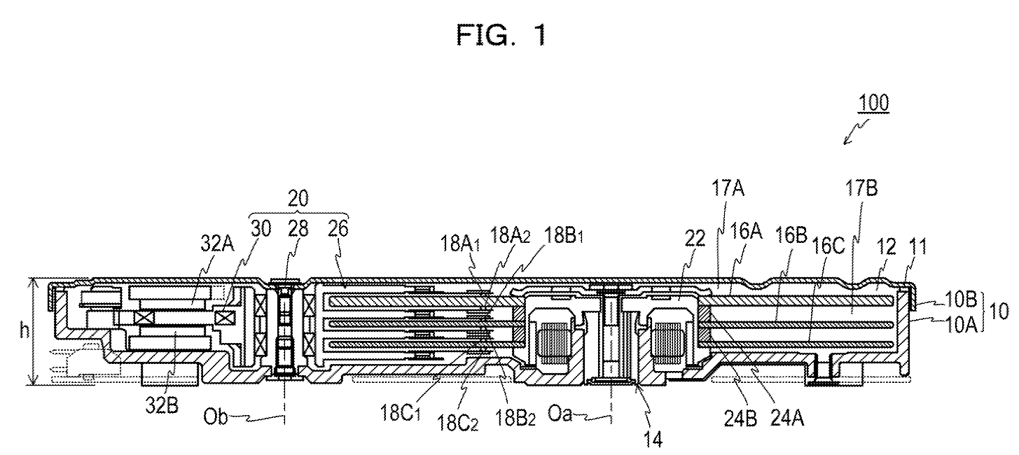

An embodiment of the present invention will be described below in detail with reference to FIGS. 1 to 4.

FIG. 1 shows a longitudinal section of a hard disk drive (HDD) 100, which is a disk device according to one embodiment. As shown in FIG. 1, the HDD 100 includes an enclosure 10 enclosing a cavity 12, a spindle motor 14 provided in the cavity 12, three magnetic disks (disk media) 16A, 16B, and 16C held by the spindle motor 14, and a head stack assembly (HSA) 20 having six magnetic heads (18A1, 18A2, 18B1, 18B2, 18C1, and 18C2) that record and reproduce (write and read) information (data) on the magnetic disks 16A to 16C.

The enclosure 10 includes a base 10A made of an aluminum alloy having the shape of a shallow box and a top cover 10B made of SUS that covers the opening at the top of the base 10A to the cavity 12 between the base 10A and the top cover 10B. The top cover 10B is fixed on the base 10A by screws or the like, with a sealing member 11 being provided between the base 10A and the top cover 10B.

The spindle motor 14 is a brushless direct-current motor that drives a hub 22 holding the magnetic disks 16A to 16C to rotate about its rotation axis Oa. The spindle motor 14 drives the hub 22 and the magnetic disks 16A to 16C to integrally rotate at a high rotation speed in the range from approximately 10,000 rpm to approximately 15,000 rpm, for example.

The magnetic disks 16A to 16C are held by the hub 22 with ring spacers 24A and 24B having the same height between them so that the spacing between the magnetic disks 16A and 16B and the spacing between the magnetic disks 16B and 16C are kept equal to each other. The magnetic disks 16A to 16C are disc-shaped recording media which include aluminum or glass substrates having magnetic and other layers formed thereon, e.g., on both surfaces. In the present embodiment, the magnetic disk 16A is 1 mm thick and the magnetic disks 16B and 16C are 0.635 mm thick, for example. Such magnetic disks having different thicknesses can be fabricated by using substrates having different thicknesses. The use of the fabrication method allows the thickness of each magnetic disk to be varied without affecting the recording and reproduction characteristics. A reason why a different thickness is chosen for the magnetic disk 16A from those of the magnetic disks 16B and 16C will be detailed later.

The HSA 20 includes a head gimbal assembly (HGA) 26, a bearing unit 28, and a VCM coil 30 which forms a voice coil motor.

The HGA 26 includes six head sliders holding the magnetic heads 18A1 to 18C2, and gimbals, suspensions, and head arms associated with the head sliders.

The VCM coil 30 forms a moving-coil-type voice coil motor (VCM) in combination with VCM magnets 32A and 32B sandwiching the VCM coil 30 in a vertical direction. Electromagnetic interaction between a current flowing through the VCM coil 30 and a magnetic field generated by the VCM magnets 32A and 32B in the voice coil motor drives the HGA 26 to rotate (pivot) about its rotation axis Ob. The pivoting motion of the HGA 26 driven by the voice coil motor causes the magnetic heads 18A1 to 18C2 to be positioned at desired locations (desired tracks) on the recording surfaces (both surfaces) of the associated magnetic disks 16A to 16C.

A reason why a different thickness is chosen for the magnetic disk 16A from those of the magnetic disks 16B and 16C in the HDD 100 of the present embodiment as mentioned above will be described next.

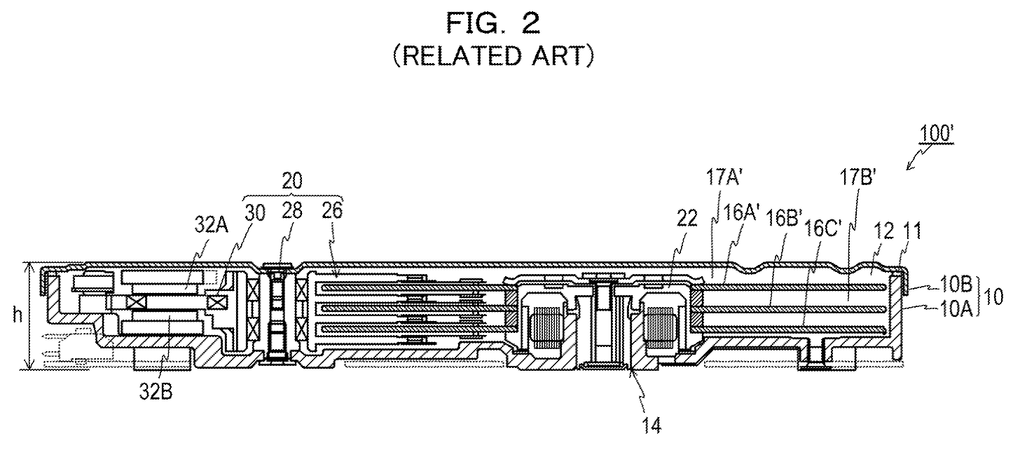

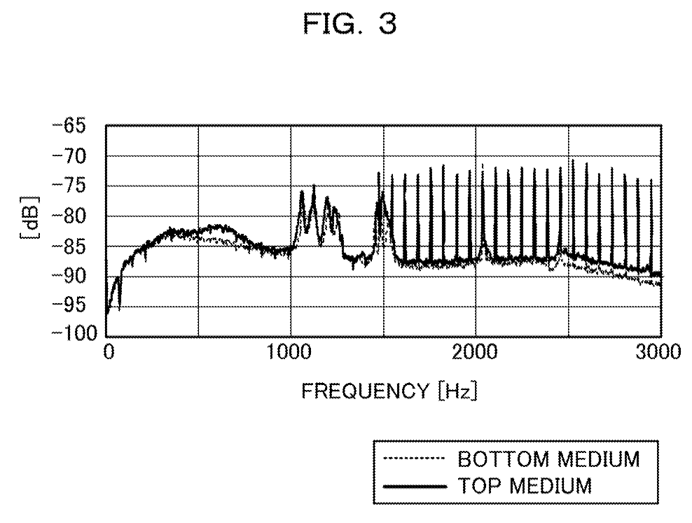

FIG. 2 shows a conventional HDD (including magnetic disks 16A′ to 16C′ having an equal thickness) 100′. FIG. 3 shows measured NRRO (Non Repeatable Runout) of the magnetic disk 16A′ at the top and measured NRRO of the magnetic disk 16C′ at the bottom in the HDD 100′. The horizontal axis of the graph of FIG. 3 represents vibrational frequency and the vertical axis represents power spectrum. The decision to measure the data depicted in FIG. 3 reflects, in part, a recognition by the present inventor of a problem in the conventional art.

It can be seen from FIG. 3 that there are significant disparities in the NRRO of the three magnetic disks 16A′, 16B′ and 16C′. In particular, FIG. 3 shows that the NRRO of the top magnetic disk 16A′ is greater than that of the bottom magnetic disk 16C′ over almost the entire vibrational frequency range. It also has been determined that the NRRO of the magnetic disk 16A′ is greater than that of the magnetic disk 16C′ by approximately 14%.

Although not shown, measurement of the NRRO of the magnetic disk 16B′ and the NRRO of the magnetic disk 16C′ was made in the same manner as described above, and the result has shown that they are approximately equal.

Without being bound by theory, it is believed that NRRO disparities are probably due to there being a greater gap 17A′ between the top cover 10B and the magnetic disk 16A′ closest to the top cover 10B than a gap 17B′ between the other magnetic disks and that, since the air in the gap is between the top over 10B and the rotating magnetic disk 16A′, air disturbance tends to occur in the gap, which increases the flutter component.

More particularly (again, without being bound by theory), in the gap 17B′, there is a laminar flow layer sandwiched between turbulent flow layers that are adjacent the surfaces of, e.g., the magnetic disks 16A′ and 16B′. Similarly, in the gap 17A′, there is a laminar flow layer sandwiched between turbulent flow layers that are adjacent the surface of the magnetic disk 16A′ and the interior surface of the top cover 10B, respectively. It is noted that the laminar flow layer of the gap 17A′ is significantly thinner than the laminar flow layer of the gap 17B′. Without (again) being bound by theory, the thinner laminar flow layer of the gap 17A′ causes the magnetic disk 16A′ to be more negatively affected by the turbulent flow layer of the gap 17A′ adjacent the top cover 10B than, e.g., the magnetic disk 16A′ is affected by the turbulent flow layer in the gap 17B′ that is adjacent the magnetic disk 16B′.

After further study based on the results described above, the present inventor has concluded (again, without being bound by theory): reduction of flapping of the magnetic disk 16A′ during rotation is an effective technique for deterring if not suppressing the occurrence of air disturbance between the magnetic disk 16A′ and the top cover 10B; and to reduce such flapping, an effective technique is to increase the structural rigidity of the magnetic disk 16A′ relative to the magnetic disks 16B′ and 16C′, e.g., by increasing the thickness of the magnetic disk 16A′ relative to the thickness of the magnetic disks 16B′ and 16C′. In other words, a result is that a gap 17A is significantly thinner than a gap 17B.

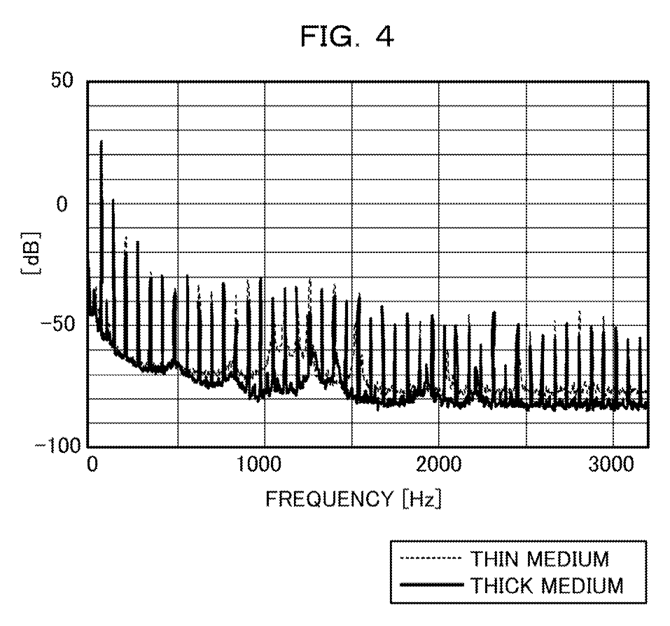

Based on the conclusion, the present inventor has measured the NRRO of magnetic disks having different thicknesses under the same conditions. The measurement has revealed that the NRRO of a thicker magnetic disk (here, 1.0 mm thick) is smaller than that of a thinner one (here, 0.635 mm thick) over almost the entire vibrational frequency range as shown in FIG. 4. It has been also shown that the NRRO of the thicker magnetic disk is smaller than that of the thinner magnetic disk by approximately 30%. The present inventor has also conducted the same experiment on magnetic disks having other thicknesses and has found that the thicker the magnetic disk is, the smaller the NRRO is.

Based on the experimental data, the present inventor has experimentally fabricated an HDD according to the present embodiment (the HDD 100 including the magnetic disk 16A thicker than the other magnetic disks 16B and 16C as shown in FIG. 1), has conducted the same experiment as in FIG. 3 on the HDD, and has found that the NRRO of the magnetic disk 16A at the top, and hence the total NRRO of the entire HDD, can be effectively reduced.

After the experiment, experimental fabrication, and simulation described above and study based on these, the present inventor has chosen to make the magnetic disk 16A thicker than the magnetic disks 16B, 16C. Of course, other techniques are contemplated for making the structural rigidity of the magnetic disk 16A greater relative to that of the magnetic disks 16B and 16C, e.g., by the choice of difference materials from which the respective disks are formed, etc.

As has been described, according to the embodiment, flutter and NRRO in the HDD 100 can be effectively reduced because the thickness of the magnetic disk 16A with a higher NRRO (especially a flutter component) than the other magnetic disks among multiple magnetic disks in the HDD 100 is made thicker than the other magnetic disks 16B, 16C to increase the structural rigidity of the magnetic disk itself to reduce flapping of the magnetic disk. The reduction can effectively deter if not suppress write and read errors of the HDD 100.

Furthermore, according to the present embodiment, NRRO (especially a flutter component) can be reduced without changing the size (height h) of the enclosure 10, that is, without increasing the size of the entire unit, as can be seen from comparison with the conventional unit (FIG. 2).

While the embodiment has been described in which the magnetic disk 16A at the top is thicker than the other magnetic disks 16B, 16C, the present invention is not limited thereto. That is, depending on the configuration of an HDD, a large air disturbance may occur in a gap other than the gap between the top cover 10B and the magnetic disk 16A. Therefore a magnetic disk other than the magnetic disk 16A may be made relatively more structurally rigid, e.g., thicker, according to the result of experiment or simulation.

While the embodiment has been described in which two types of magnetic disks having different thicknesses are used in the HDD 100, the present invention is not limited thereto. More than two types of magnetic disks may be used according to NRRO and flutter measurements. As a result, the levels of NRRO and flutter occurring in the HDD can be made practically uniform.

While the embodiment has been described in which the spacing between the magnetic disks 16A and 16B and the spacing between the magnetic disks 16B and 16C are equal, the present invention is not limited thereto. The spacings may be different.

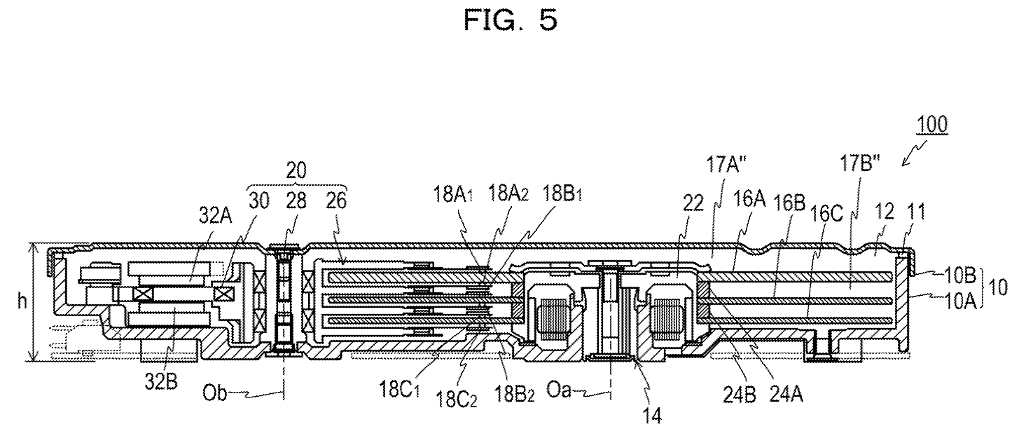

While the embodiment has been described in which the gap 17A is significantly thinner than a gap 17B, the present invention is not limited thereto. Alternatively, a gap 17A″ may be provided that is significantly thicker than a gap 17B″, as depicted in FIG. 5. More particularly (without being bound by theory), the thicker laminar flow layer of the gap 17A″ causes the magnetic disk 16A to be less negatively affected by the turbulent flow layer of the gap 17A″ adjacent the top cover 10B than, e.g., the magnetic disk 16A′ is affected by the turbulent flow layer in the gap 17B″ that is adjacent the magnetic disk 16B. Hence, flutter suffered by the magnetic disk 16A is reduced.

While the embodiment has been described in which the magnetic disk at the top (a magnetic disk having a high NRRO measurement) is uniformly thick over the entirety, the present invention is not limited thereto. At least a portion of the magnetic disk at the top (or a magnetic disk having a higher NRRO measurement) may be thicker than the rest of the disks. Such a magnetic disk 16A″′ can be described as having different moment of inertia than the other magnetic disks, e.g., a different cross-sectional profile than the other magnetic disks, e.g., 16B″′. In this case, the portions nearer to the outer edge of the disk may be thicker than the inner portion of the disk, to the extent that data can be read and written by the magnetic heads. Alternatively, a different moment of inertia may be achieved, e.g., by providing of the magnetic disk at the top (or a magnetic disk having a higher NRRO measurement) with a different diameter, e.g., a larger diameter, than the rest of the disks.

While the embodiment has been described with respect to the HDD 100 including three magnetic disks, the present invention is not limited thereto. The HDD 100 may include two or more than three magnetic disks. In either case, the use of the same configuration as the present embodiment described above can suppress the occurrence of flutter due to flapping of magnetic disks as compared with the conventional technique (in which magnetic disks are spaced at different spacings).

The embodiment described above is a preferred exemplary embodiment. The present invention is not limited to this but various modifications can be made without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A disk device comprising:
an enclosure to enclose a cavity;
a plurality of disk media rotatably mounted in the enclosure and arranged along a rotation axis; and
heads, movably mounted in the enclosure, to read/record data from/onto each the corresponding disk media, respectively;
at least a first one of the plurality of disk media exhibiting a structural rigidity different than at least a second of the plurality of disk media.

2. The disk device according to claim 1, wherein a thickness of the first disk medium is different than a thickness of the second disk medium such that the structural rigidity of the first disk medium is different than the structural rigidity of the second disk medium.

3. The disk device according to claim 2, wherein:
the enclosure includes a base to which the plurality of disk media are rotatably mounted and a top cover; and
the first disk medium is disposed closer to the top cover than the other disk media.

4. The disk device according to claim 2, wherein:
each of the plurality of disk media includes a substrate and one or more layers formed thereon; and
a thickness of the substrate of the first disk medium is different than a thickness of the substrate of the second disk medium such that the structural rigidity of the first disk medium is different than the structural rigidity of the second disk medium.

5. The disk device according to claim 1, wherein a material of the first disk medium is different than a material of the second disk medium such that the structural rigidity of the first disk medium is different than the structural rigidity of the second disk medium.

6. The disk device according to claim 1, wherein a cross-sectional profile of the first disk medium is different than a cross-sectional profile of the second disk medium such that the structural rigidity of the first disk medium is different than the structural rigidity of the second disk medium.

7. The disk device according to claim 1, wherein a diameter of the first disk medium is different than a diameter of the second disk medium such that the structural rigidity of the first disk medium is different than the structural rigidity of the second disk medium.

8. A disk device comprising:
an enclosure to enclose a cavity;
a plurality of disk media rotatably mounted in the enclosure and arranged along a rotation axis, each of the disk media having first and second major planar surfaces, each of the disk media being disposed in the enclosure such that air gaps are provided adjacent the first and second major planar surfaces, respectively; and
heads, movably mounted in the enclosure, to read/record data from/onto each the corresponding disk media, respectively;
a cross-sectional profile of at least one air gap adjacent at least a first one of the plurality of disk media being different than a cross-sectional profile of at least one air gap adjacent at least a second one of the plurality of disk media that a laminar flow adjacent the first disk medium is substantially the same as a laminar flow adjacent the second disk medium.

9. The disk device according to claim 8, wherein a thickness of the first disk medium is different than a thickness of the second disk medium such that the structural rigidity of the first disk medium is different than the structural rigidity of the second disk medium.

10. The disk device according to claim 9, wherein:
each of the plurality of disk media includes a substrate and one or more layers formed thereon; and
a thickness of the substrate of the first disk medium is different than a thickness of the substrate of the second disk medium such that the structural rigidity of the first disk medium is different than the structural rigidity of the second disk medium.

11. The disk device according to claim 9, wherein a material of the first disk medium is different than a material of the second disk medium such that the structural rigidity of the first disk medium is different than the structural rigidity of the second disk medium.

12. The disk device according to claim 9, wherein a cross-sectional profile of the first disk medium is different than a cross-sectional profile of the second disk medium such that the structural rigidity of the first disk medium is different than the structural rigidity of the second disk medium.

13. The disk device according to claim 9, wherein a diameter of the first disk medium is different than a diameter of the second disk medium such that the structural rigidity of the first disk medium is different than the structural rigidity of the second disk medium.
